(19) United States
(12) Patent Application Publication
(10) Pub. No.: US 2020/0409623 A1
(43) Pub. Date: Dec. 31, 2020

(54) IMAGE FORMING APPARATUS

(71) Applicant: KYOCERA Document Solutions Inc., Osaka-shi (JP)

(72) Inventor: Chigusa Tanaka, Osaka-shi (JP)

(21) Appl. No.: 16/905,333

(22) Filed: Jun. 18, 2020

(30) Foreign Application Priority Data
Jun. 26, 2019 (JP) 2019-118065

(51) Int. Cl. G06F 3/12

(52) U.S. Cl. CPC G06F 3/1222; G06F 3/1238

(57) ABSTRACT

An image forming apparatus includes a printing device and a print job management unit that executes a box print job for printing a document in a document box with the printing device according to a job request made by a user. The print job management unit executes the box print job as a secure print job when a predetermined setting of the document box is of a predetermined value, and executes the box print job as a non-secure print job when the predetermined setting of the document box is not of the predetermined value. The print job management unit resumes the box print job after user authentication when the box print job as the secure print job is interrupted, and resumes the box print job without the user authentication when the box print job as the non-secure print job is interrupted.

### INCORPORATION BY REFERENCE

This application is based upon and claims the benefit of priority from the corresponding Japanese Patent Application No. 2019-118065 filed on Jun. 26, 2019, the entire contents of which are incorporated herein by reference.

### BACKGROUND

The present disclosure relates to an image forming apparatus.

When executing a secure print job, an image forming apparatus starts printing a document designated by the secure print job after authentication processing. Thereafter, when the secure print job is interrupted, the secure print job is resumed after the authentication processing.

However, when a document stored in a document box is printed, even if the document box is a document box storing a highly confidential document, there is a possibility that the document is printed by a non-secure print job. This is undesirable for security reasons.

The present disclosure provides an image forming apparatus that prints a document stored in a highly confidential document box while maintaining confidentiality.

### SUMMARY

An image forming apparatus according to the present disclosure includes a printing device and a print job management unit that executes a box print job for printing a document in a document box with the printing device according to a job request made by a user. The print job management unit executes the box print job as a secure print job when a predetermined setting of the document box is of a predetermined value, and executes the box print job as a non-secure print job when the predetermined setting of the document box is not of the predetermined value. The print job management unit resumes the box print job after user authentication when the box print job as the secure print job is interrupted, and resumes the box print job without the user authentication when the box print job as the non-secure print job is interrupted.

### BRIEF DESCRIPTION OF THE DRAWINGS

FIG. 1 is a block diagram illustrating a configuration of an image forming apparatus according to an embodiment of the present disclosure.

FIG. 2 is a flowchart for explaining a box print job in the image forming apparatus shown in FIG. 1.

FIG. 3 is a flowchart for explaining processing when a box print job is interrupted in the image forming apparatus shown in FIG. 1.

### DETAILED DESCRIPTION

Hereinafter, an embodiment of the present disclosure will be described with reference to the drawings.

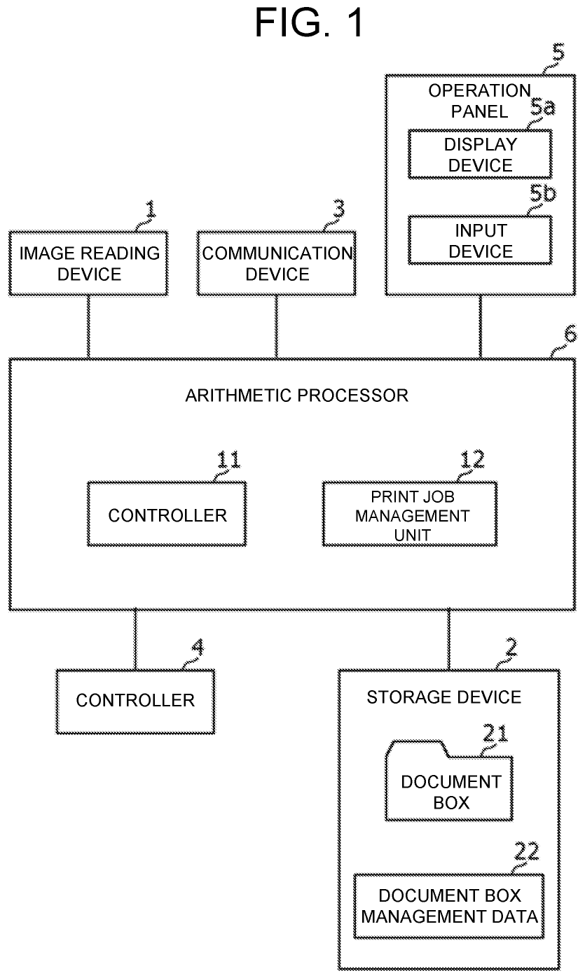

FIG. 1 is a block diagram illustrating a configuration of an image forming apparatus according to an embodiment of the present disclosure. The image forming apparatus shown in FIG. 1 is such an image forming apparatus as a multifunction peripheral. The image forming apparatus shown in FIG. 1 includes an image reading device 1, a storage device 2, a communication device 3, a printing device 4, an operation panel 5, and an arithmetic processor 6.

The image reading device 1 is an internal device that optically reads a document image from a document and generates image data (here, RGB data) of the document image.

The storage device 2 is a device capable of storing various data and programs. As the storage device 2, a nonvolatile mass storage medium such as a nonvolatile memory or a hard disk drive is used. The storage device 2 is provided with a document box 21. The storage device 2 stores document box management data 22.

The document box management data 22 includes setting data of the document box 21. The setting data of the document box 21 includes sharing setting data of the document box 21, password setting data of the document box 21, and the like. The sharing setting data includes ON/OFF of the sharing setting, a user condition (for example, a user attribute such as a user name or user authority) for permitting reading or printing of a document in the document box 21, and the like. The password setting data includes ON/OFF of the password setting, a password for permitting reading and printing of a document in the document box 21, and the like.

The communication device 3 includes a modem, a network interface, and the like, and performs data communication for facsimile transmission, file transfer, and the like.

In addition, the printing device 4 prints an image based on image data on a printing sheet by, for example, an electrophotographic method.

The operation panel 5 includes a display device 5a such as a liquid crystal display for displaying various screens to the user, and an input device 5b such as a touch panel and hard keys for detecting user operations.

The arithmetic processor 6 is a computer including a central processing unit (CPU), a read only memory (ROM), a random access memory (RAM), and the like. The arithmetic processor 6 functions as various processors by loading a program from the ROM, the storage device 2 or the like into the RAM and executing the program by the CPU. In this embodiment, the arithmetic processor 6 functions as a controller 11 and a print job management unit 12.

Upon accepting a job request for a job such as a print job, the controller 11 appropriately executes image processing (screen processing or the like) on image data of a document designated by the job request to generate image data for printing. Then, the controller 11 executes a print job using the printing device 4 based on the generated image data.

For example, in a job request for a box print job, a document box or a document in the document box is designated.

The print job management unit 12 accepts a job request made by a user that is received from a host apparatus (not shown) by the communication device 3 or a job request made by a user that is input through the operation panel 5. Then, the print job management unit 12 executes a print job such as a box print job for printing a document in the document box by the printing device 4 in accordance with the job request. In the print job, the print job management unit 12 uses the controller 11 to cause the printing device 4 to execute printing. Specifically, when a predetermined setting of the document box 21 is of a predetermined value, the print job management unit 12 executes the box print job as a secure print job. When the predetermined setting of the document box 21 is not of the predetermined value, the print job management unit 12 executes the box print job as a non-secure print job.

The secure print job is a print job, in which authentication such as user authentication, personal identification number (PIN) authentication or password authentication is required at the start of printing. The non-secure print job is a print job, in which such authentication is not required at the start of printing. User authentication is required in the secure print job when the job is resumed after interruption. On the other hand, in the non-secure print job, user authentication is not required at the time of resuming the job after interruption.

In the user authentication, the user who is operating the image forming apparatus is specified by the user ID and the password input through the operation panel 5. If the specified user is the user who has made the job request for the box print job (or the user who is permitted to print the document in the document box 21), the user authentication is successful, that is to say, the user authentication is unsuccessful if the specified user is not such user.

When the box print job as the secure print job is interrupted, the print job management unit 12 resumes the box print job after the user authentication. On the other hand, when the box print job as the non-secure print job is interrupted, the print job management unit 12 resumes the box print job without any user authentication.

In this embodiment, the print job management unit 12 refers to the document box management data 22 to determine whether the sharing setting of the document box 21 designated by the job request is OFF. When the sharing setting of the document box 21 is OFF, the print job management unit 12 executes the box print job as a secure print job. On the other hand, when the sharing setting of the document box 21 is ON, the print job management unit 12 executes the box print job as a non-secure print job.

In this embodiment, the print job management unit 12 refers to the document box management data 22 to determine whether the password setting of the document box 21 designated by the job request is ON. When the password setting of the document box 21 is ON, the print job management unit 12 executes the box print job as a secure print job. On the other hand, when the password setting of the document box 21 is OFF, the print job management unit 12 executes the box print job as a non-secure print job.

Further, in this embodiment, when a box print job as a secure print job is interrupted and the cause of the interruption of the box print job is removed, the print job management unit 12 immediately resumes the box print job if the user who has made the job request is logging in. On the other hand, if the user who has made the job request is not logging in, the print job management unit 12 resumes the box print job after user authentication.

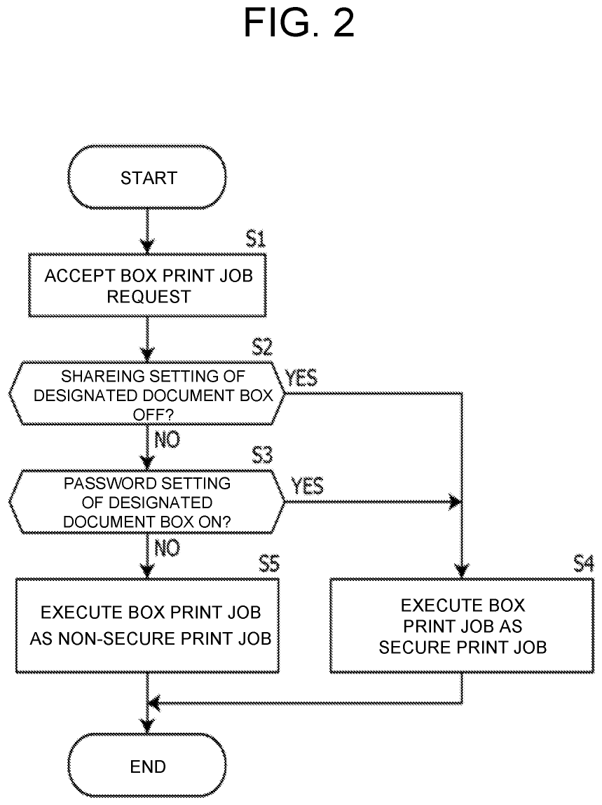

Next, the operation of the image forming apparatus will be described. FIG. 2 is a flowchart for explaining a box print job in the image forming apparatus shown in FIG. 1.

Upon accepting a box print job request (step S1), the print job management unit 12 specifies the document box 21 designated by the request and the document in the document box 21. Then, the print job management unit 12 determines whether the sharing setting of the document box 21 is OFF (step S2) and whether the password setting of the document box 21 is ON (step S3).

When the sharing setting of the document box 21 is OFF and/or the password setting of the document box 21 is ON, other users cannot freely read or print the document in the document box 21, and the document in the document box 21 is highly confidential. Therefore, the print job management unit 12 automatically executes the requested box print job as a secure print job (step S4). At this time, a PIN for PIN authentication, a password for password authentication, and the like are set by the user as necessary, and the print job management unit 12 is notified of such PIN, password, and the like by a job request.

On the other hand, when the sharing setting of the document box 21 is not OFF and the password setting of the document box 21 is not ON, the confidentiality of the document in the document box 21 is not high. Therefore, the print job management unit 12 automatically executes the requested box print job as a non-secure print job (step S5).

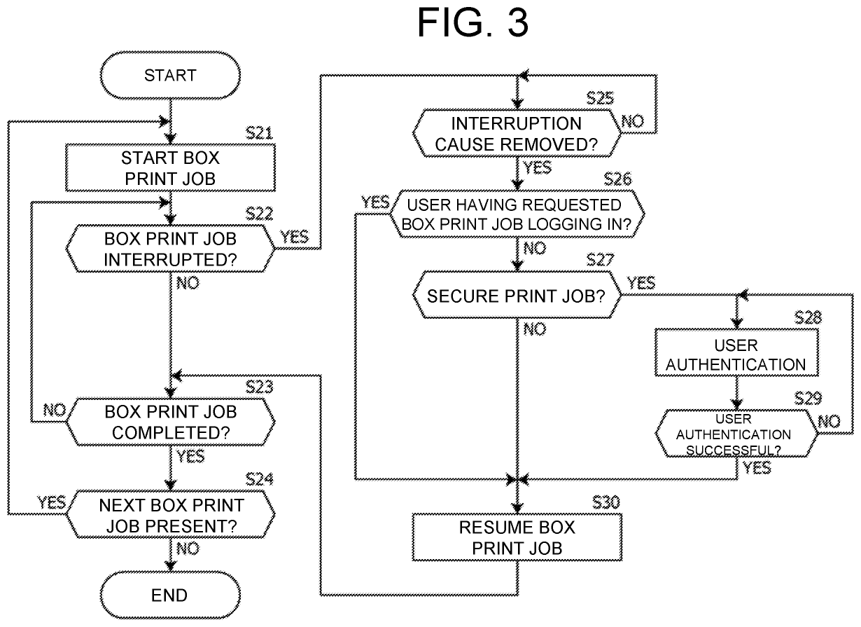

Here, processing when the box print job is interrupted will be described. FIG. 3 is a flowchart for explaining processing when a box print job is interrupted in the image forming apparatus shown in FIG. 1.

As shown in FIG. 3, a box print job is started (step S21), and the print job management unit 12 causes the printing device 4 to print a document requested in the box print job. At that time, the print job management unit 12 interrupts the box print job (step S22) when a predetermined event (a user operation for temporary stop, an internal error such as a jam or paper out, or the like) is detected. When the box print job is completed without interrupting the box print job (step S23), the print job management unit 12 ends the processing if there is no next box print job.

When the box print job is interrupted, the print job management unit 12 monitors whether or not the cause of the interruption is removed (step S25), and when the cause of the interruption is removed, determines whether or not the user having requested the box print job is logging in (step S26). Since user authentication is performed when a user logs in to the image forming apparatus, the user, who is logging in, is specified by the user authentication. In step S26, it is determined whether or not the user, who is logging in, is identical to the user having made the job request for the box print job, who is indicated by the job request.

If the user having requested the box print job is not logging in, the print job management unit 12 determines whether the box print job is a secure print job (step S27).

When the box print job is a secure print job, the print job management unit 12 displays a user authentication screen on the operation panel 5 and detects, on the operation panel 5, user identification information (for example, a user ID and a password) input to the user authentication screen. Then, the print job management unit 12 refers to user registration data (not shown) to determine whether the input user identification information is valid, thereby performing user authentication (step S28).

If the user authentication is successful, the print job management unit 12 resumes the interrupted box print job (step S30). On the other hand, if the user authentication is unsuccessful, the print job management unit 12 performs the user authentication again.

If the box print job is a non-secure print job, the print job management unit 12 automatically and immediately resumes the interrupted box print job (step S30).

If the user having requested the box print job is logging in, the print job management unit 12 automatically and immediately resumes the interrupted box print job regardless of whether the box print job is a secure print job (step S30). In this manner, the interrupted box print job is immediately resumed without any operations performed by the user having requested the box print job for the user authentication.

In this way, a box print job is interrupted each time an interruption cause occurs, and when the box print job is a secure print job, the box print job is resumed after user authentication.

According to the embodiment as described above, the print job management unit 12 executes the box print job as a secure print job when a predetermined setting of the document box 21 is of a predetermined value, and executes the box print job as a non-secure print job when the predetermined setting of the document box 21 is not of the predetermined value. When the box print job as a secure print job is interrupted, the print job management unit 12 resumes the box print job after the user authentication. When the box print job as a non-secure print job is interrupted, the print job management unit 12 resumes the box print job without any user authentication.

As a result, printing is carried out with a good user convenience with respect to the box print job designating the document box 21 having low confidentiality, and a document stored in the document box 21 having high confidentiality is printed while maintaining confidentiality.

Various changes and modifications of the embodiment described above will be apparent to those skilled in the art. Such changes and modifications can be made without departing from the spirit and scope of the subject matter and without diminishing intended advantages. It is therefore intended that such changes and modifications be covered by the appended claims.

For example, the document box 21 in the above embodiment may be provided in an external server (not shown). In that case, the print job management unit 12 accesses the document box 21 in the external server using the communication device 3.

What is claimed is:

1. An image forming apparatus comprising:
a printing device; and
a print job management unit that executes a box print job for printing a document in a document box with the printing device according to a job request made by a user,
wherein the print job management unit executes the box print job as a secure print job when a predetermined setting of the document box is of a predetermined value, and executes the box print job as a non-secure print job when the predetermined setting of the document box is not of the predetermined value, and
wherein the print job management unit resumes the box print job after user authentication when the box print job as the secure print job is interrupted, and resumes the box print job without the user authentication when the box print job as the non-secure print job is interrupted.

2. The image forming apparatus according to claim 1, wherein the print job management unit executes the box print job as the secure print job when a sharing setting of the document box is OFF, and executes the box print job as the non-secure print job when the sharing setting of the document box is ON.

3. The image forming apparatus according to claim 1, wherein the print job management unit executes the box print job as the secure print job when a password setting of the document box is ON, and executes the box print job as the non-secure print job when the password setting of the document box is OFF.

4. The image forming apparatus according to claim 1, wherein, when the box print job as the secure print job is interrupted and a cause of interruption of the box print job is removed, the print job management unit immediately resumes the box print job if the user, who has made the job request, is logging in, and resumes the box print job after the user authentication if the user, who has made the job request, is not logging in.
